(19) United States
(12) Patent Application Publication
(10) Pub. No.: US 2009/0113370 A1
(43) Pub. Date: Apr. 30, 2009

(54) Layout designing method for semiconductor device and layout design supporting apparatus for the same

(75) Inventor: Hiroko Yoshinaga, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/289,490

(22) Filed: Oct. 29, 2008

(30) Foreign Application Priority Data
Oct. 30, 2007 (JP) 2007-281341

(51) Int. Cl. G06F 17/50

(52) U.S. Cl. 716/11

(57) ABSTRACT

In a layout designing method of a semiconductor device, a first standard cell with a first well and a second standard cell with a second well are arranged. The first well and the second well are applied with different voltages, respectively. An empty cell is arranged in an area that a distance from the first well falls within a first distance. The second standard cell is moved such that the empty cell does not overlap with the empty cell, when the empty cell overlaps with the second well.

### INCORPORATION BY REFERENCE

This patent application claims priority on convention based on Japanese Patent Application No. 2007-281341. The disclosure thereof is incorporated herein by reference.

### BACKGROUND OF THE INVENTION

1. Field of the Invention

The present invention relates to a technique for a layout design of a semiconductor device, and more particularly relates to a layout designing method of a semiconductor device and a layout design supporting apparatus for the same.

2. Description of Related Art

As a scheme of the layout design of a semiconductor device, a standard cell method is known. In the standard cell method, a plurality of kinds of standard cells are prepared in which circuit operations are verified in advance. The standard cell includes circuit patterns, which are required to attain basic logic functions of an inverter, a NAND, a NOR, a flip-flop and so on.

FIG. 1 is a flowchart showing an example of a conventional layout designing method using the standard cell method. At first, a floor plan for indicating a chip size and the arrangement of hard blocks is determined in accordance with terminal data D102 of standard cells and hard blocks (ROM (Read Only Memory) and RAM (Random Access Memory)) and a netlist D101 (Step S101). Next, power supply patterns are arranged (Step S102). Then, the standard cells required to have desirable logic functions are selected and automatically arranged in accordance with the net list D101, and a timing data D103 (Step S103). Moreover, interconnections are laid between the standard cells (Step S104).

On the other hand, smaller consumed power and lower noise are required for the semiconductor device. In order to satisfy such requirements, there is a case that different voltages are supplied to the same chip from different power supplies.

Transistors are formed in the semiconductor device. The transistors are usually formed inside a well. In case of the semiconductor device to which the different voltages are supplied from the different power supplies, the wells connected to the different power supplies are considered to be adjacent to each other. Thus, the voltages of the well themselves are different between the wells connected to the different power supplies. Therefore, since a leakage current flows between the wells, there are a case of the voltage drop in the well and the increase in the consumed power. For this reason, the wells are required to be arranged separately from each other so that the leakage current does not flow.

When the standard cell method is used to design a layout, a method is known in which in order to prevent the wells applied with the different voltages from being adjacent to each other, a certain area is defined for each power supply, and the standard cells are arranged inside the defined area. FIG. 2 is a diagram schematically showing a layout pattern when the certain area is defined for each power supply and the standard cells are arranged. In the example shown in FIG. 2, certain areas (A1, A2) are respectively defined for difference power supplies (VDD1, VDD2). Standard cells (1A-1, 1A-2, 1A-3 and 1A-4) to which the voltages are supplied from the power supply VDD1 are arranged inside the area A1, and standard cells (2A-1, 2A-2) to which the voltages are supplied from the power supply VDD2 are arranged inside the area A2. It should be noted that the hard blocks such as ROM (Read Only Memory) and RAM (Random Access Memory) are arranged inside the area A1, apart from the standard cells.

As shown in FIG. 2, when the area where the standard cells are arranged is defined for each power supply, the wells applied with the different voltages can be prevented from being adjacent to each other. However, since a limit is set to the position where each standard cell is arranged, a distance between the standard cells between which a signal is sent and received is easy to be far away. Thus, an interconnection delay time is easy to be increased, and it becomes difficult to realize an operation at a high speed.

On the other hand, in Japanese Patent Application Publication (JP-P2004-22877A: related art 1), a technique is described for designing a layout without fixing an area in which the standard cells are arranged for each power supply. In this related art 1, an N-well is arranged separately from the entire circumference of the boundary of the cell. Thus, even if the cells are adjacent to each other, the N-well inside the standard cell can be separated from the N-well of the adjacent cell.

As described in the related 1, when the standard cell is used in which the N-well is arranged separately from the boundary circumference (hereinafter, to be referred to as a standard cell for a difference power supply), it is not unnecessary to define the area in which the standard cells are arranged for each power supply, so that the increase in the interconnection delay time can be avoided.

However, an area to reserve a well interval is included inside the standard cell for a difference power supply. For this reason, the area occupied by one standard cell for the difference power supply is increased, so that the chip size also increases. This will be described below with reference to FIGS. 3 and 4. FIG. 3 is a diagram schematically showing a standard cell for a difference power supply. The standard cell includes a P-well 101, an N-well 102 and an area 103. It should be noted that although transistors are actually formed in the P-well 101 and the N-well 102, the transistors are omitted. Since the N-well 102 is arranged separately from the boundary circumference of the cell, the area 103 is formed between the N-well 102 and the boundary circumference of the cell. FIG. 4 is a diagram schematically showing a layout pattern of a semiconductor device whose layout is designed by using standard cells for difference power supplies. On the layout pattern shown in FIG. 4, a plurality of standard cells 100 to which the power supply voltage VDD1 is supplied and a plurality of standard cells 200 to which the power supply voltage VDD2 is supplied are drawn. The N-well 102 is provided in each of the plurality of standard cells 100, and an N-well 202 is provided in each of the plurality of standard cells 200. Some of the standard cells 100 are arranged in adjacent to each other. Similarly, some of the plurality of standard cells 200 are also arranged in adjacent to each other. In the area where the standard cells 100 are located in adjacent to each other, the voltages applied with the N-wells 102 are originally equal. Thus, even if the N-wells 102 are adjacent to each other, leakage current does not flow. However, since the area 103 is provided in each standard cell 100, a problem is generated between the N-wells 102. The area where the plurality of standard cells 200 are located in adjacent to each other is similar. In this way, even in the area where the standard cells connected to the same power supply are adjacent to each other, the area 103 is arranged between the N-wells. Thus, the chip size is made large.

### SUMMARY

In an aspect of the present invention, a layout designing method of a semiconductor device, includes: arranging a first standard cell with a first well and a second standard cell with a second well, wherein the first well and the second well are applied with different voltages, respectively; arranging an empty cell in an area that a distance from the first well falls within a first distance; and moving the second standard cell such that the empty cell does not overlap with the empty cell, when the empty cell overlaps with the second well.

In another aspect of the present invention, a layout design supporting apparatus for a semiconductor device, includes: a first arranging section configured to arrange a first standard cell with a first well and a second standard cells with a second well, to generate an arranged layout data, wherein different voltages are applied to the first and second wells, respectively; an empty cell arranging section configured to arrange an empty cell in an area within a first distance from the first well, to generate an empty cell arranged layout data; and a second arranging section configured to re-arrange the second standard cell such that the empty cell and the second well do not overlap, when the empty cell overlaps with the second standard cell in the empty cell arranged layout data.

In still another aspect of the present invention, a computer-readable recording medium is provided in which a computer-readable program code is stored for realizing a layout designing method of a semiconductor device. The layout designing method includes: arranging a first standard cell with a first well and a second standard cell with a second well, wherein the first well and the second well are applied with different voltages, respectively; arranging an empty cell in an area that a distance from the first well falls within a first distance; and moving the second standard cell such that the empty cell does not overlap with the empty cell, when the empty cell overlaps with the second well.

According to the present invention, the method of designing the layout of the semiconductor device is provided, in which the increase in chip size is suppressed and the wells connected to the different power supplies are arranged so as not to be adjacent to each other.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a flowchart showing a layout designing method of a semiconductor device which uses a standard cell method;

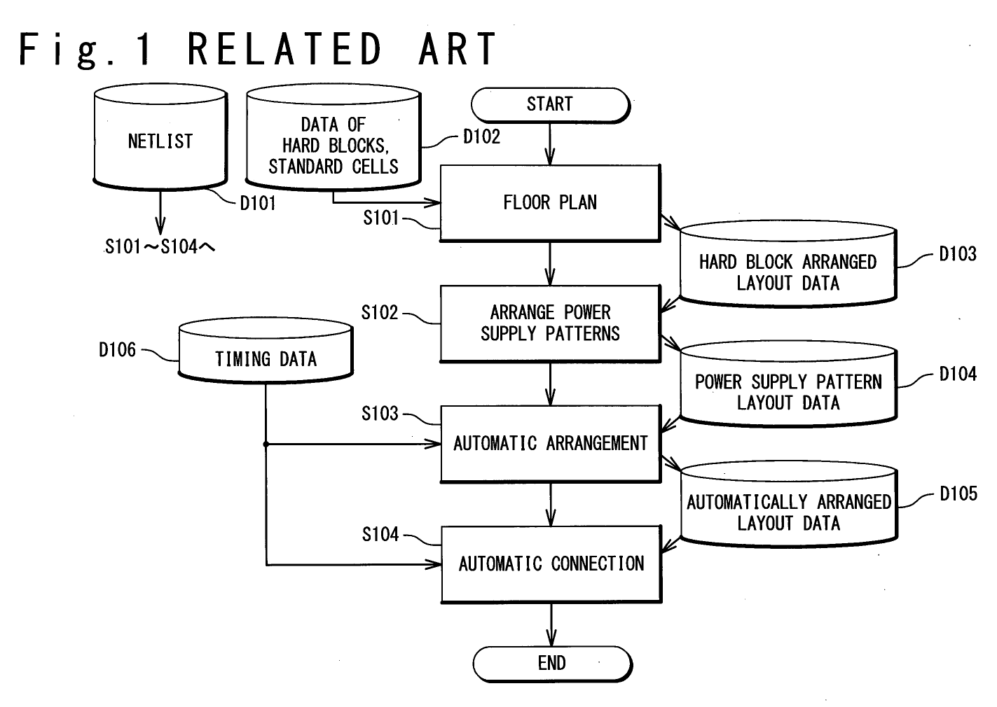

FIG. 2 is a conceptual diagram of a layout pattern generated by the layout designing method of the semiconductor device;

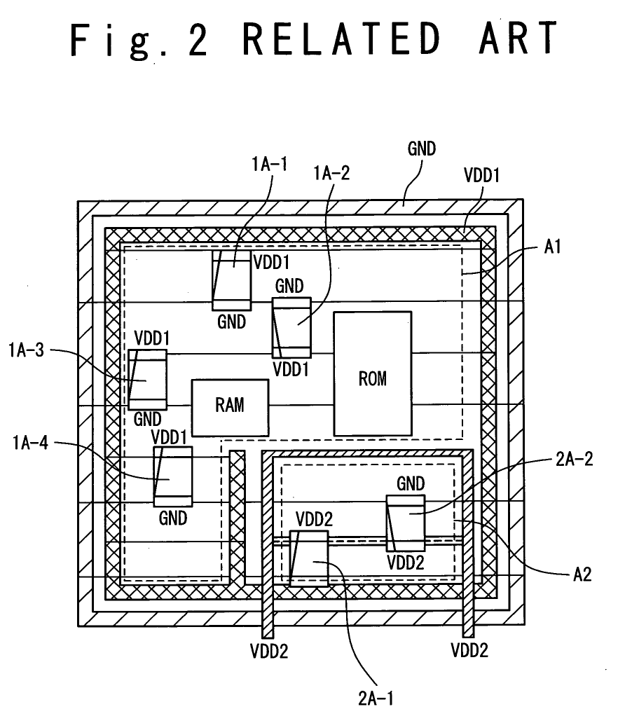

FIG. 3 is a diagram schematically showing a standard cell for a difference power supply;

FIG. 4 is a diagram schematically showing a layout pattern of a semiconductor device whose layout is designed by using the standard cells for difference power supplies;

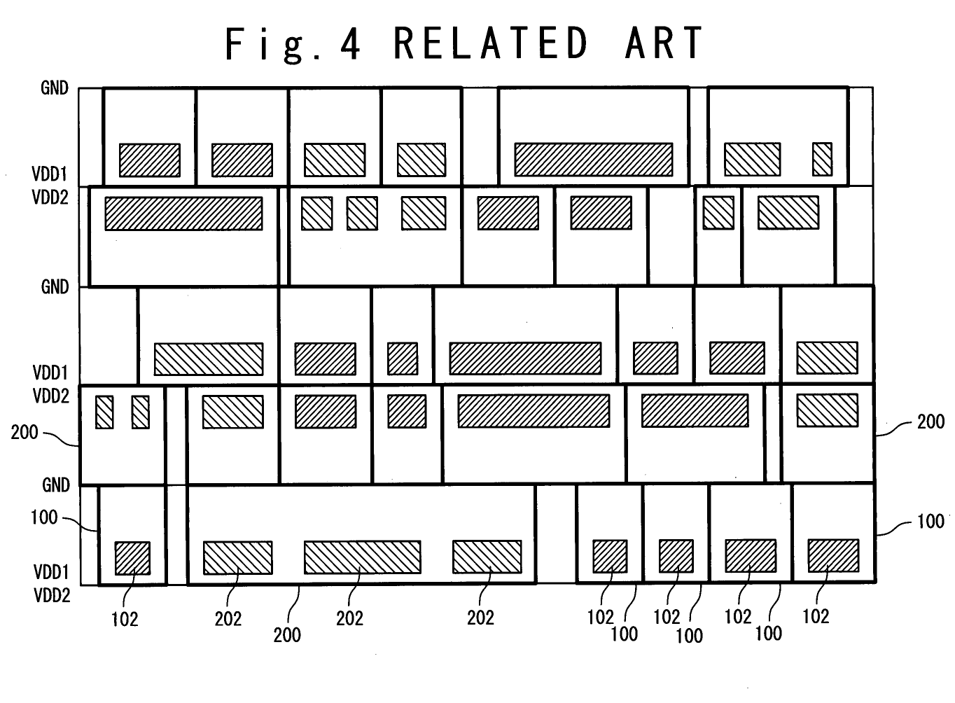

FIG. 5 is a function block diagram showing the function configuration of a layout design supporting apparatus according to a first embodiment of the present invention;

FIG. 6 is a diagram schematically showing a pattern of each standard cell;

FIG. 7 is a flowchart showing an operation of the layout design supporting apparatus in the first embodiment;

FIG. 8 is a conceptual diagram showing the power supply arranged layout data;

FIG. 9 is a conceptual diagram showing an interconnection arranged layout data;

FIG. 10 is a conceptual diagram showing the power supply group list;

FIG. 11 is a diagram showing a position where an empty cell is arranged;

FIG. 12 is a conceptual diagram showing the empty cell arranged layout data;

FIG. 13 is a conceptual diagram showing an empty cell removed layout data;

FIG. 14 is a conceptual diagram showing a layout pattern designed when first standard cells and second standard cells are alternately arranged;

FIG. 15 is a block diagram showing the function configuration of the layout design supporting apparatus for a semiconductor device according to a second embodiment of the present invention;

FIG. 16 is a flowchart showing the operation of the layout design supporting apparatus in the second embodiment;

FIG. 17A is a conceptual diagram showing the arrangement of the standard cells on a standard cell row in the interconnection arranged layout data;

FIG. 17B is a conceptual diagram showing a re-arranged layout data; and

FIG. 18 is a conceptual diagram showing a layout data after the process until the step 6 is performed on the re-arranged layout data.

### DESCRIPTION OF THE PREFERRED EMBODIMENTS

Hereinafter, a layout design supporting apparatus for a semiconductor device according to the present invention will be described in detail with reference to the attached drawings.

### First Embodiment

A layout design supporting apparatus 1 of the semiconductor device according to a first embodiment of the present invention is realized by a computer that has ROM, RAM, CPU and the like. A layout designing program for the semiconductor device is loaded from a recording medium into the RAM and executed by the CPU.

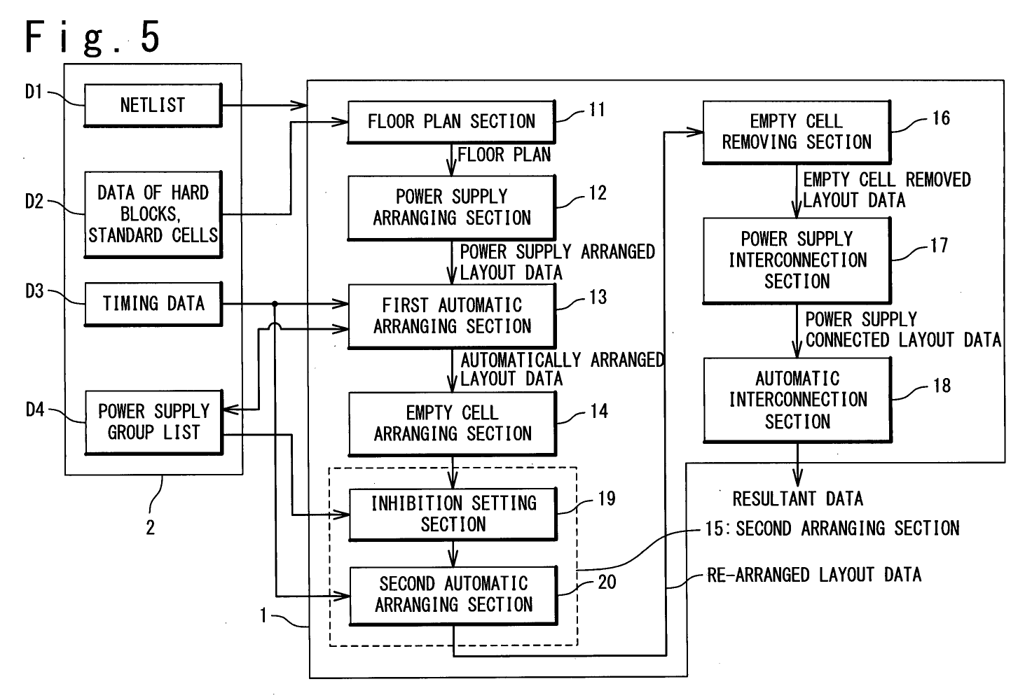

FIG. 5 is a block diagram showing the function configuration of the layout design supporting apparatus 1. The layout design supporting apparatus 1 contains a floor plan section 11, a power supply arranging section 12, a first automatic arranging section 13, an empty cell arranging section 14, a second arranging section 15, an empty cell removing section 16, a power supply interconnection section 17 and an automatic interconnection section 18. The second arranging section 15 contains an inhibition setting section 19 and a second automatic arranging section 20.

The layout design supporting apparatus 1 is accessibly connected to a storage unit 2. The storage unit 2 has a function for storing various data, and is exemplified by a hard disc, and RAM. The storage unit 2 stores in advance, a net list D1 which describes a connection relation between logic circuits in a layout pattern to be designed; a data D2 as data of various kinds of hard blocks and standard cells; and a timing data D3 which describes timing constraints. Each of the standard cells includes a pattern of a circuit for achieving a basic logic function. Also, each of the hard blocks includes a pattern of a logic circuit having a specific function such as CPU, ROM, and RAM, and this is prepared separately from the standard cells. The data D2 also includes a terminal data indicating the attribute of terminals of each of the hard blocks and the standard cells.

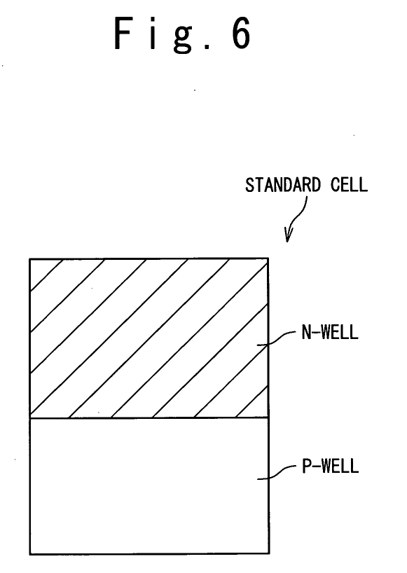

FIG. 6 is a diagram schematically showing a pattern of each standard cell. The standard cell is rectangular and includes an N-well connected to a power supply and a P-well connected to the ground. It should be noted that although not shown in FIG. 6, logic circuits including transistors are formed on those wells. Also, terminals for input and output of signals, power supply terminals, and ground terminals are provided in the standard cell. In this embodiment, the N-well is not always required to be arranged separately from the boundary circumference of the standard cell, and the circumference of each standard cell is formed by the outer circumferences of the P-well and the N-well.

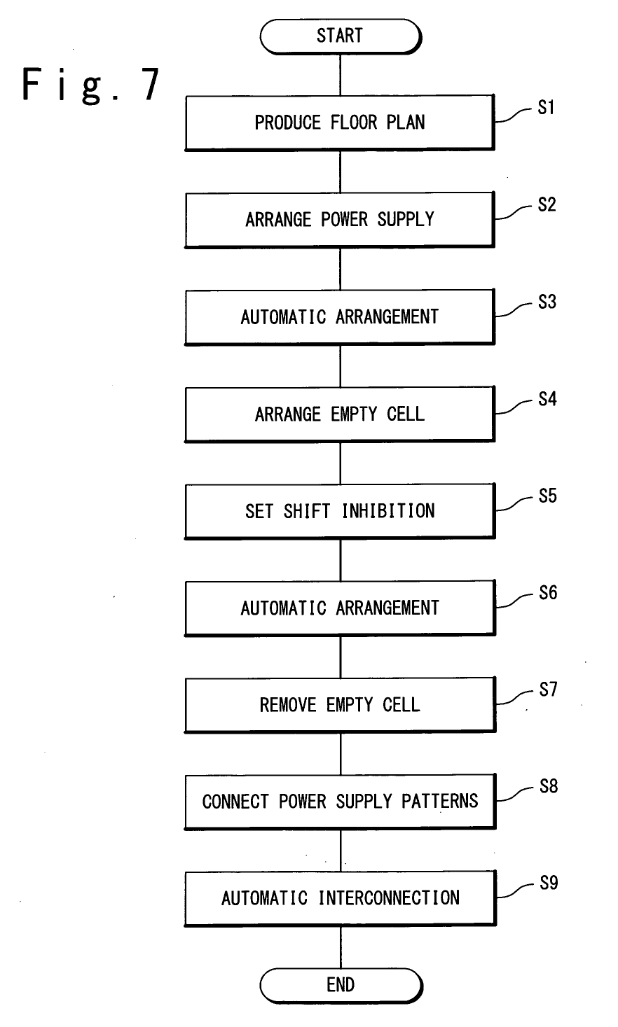

FIG. 7 is a flowchart showing an operation of the layout design supporting apparatus 1 for a semiconductor device. The layout of the semiconductor device is designed through the operation of steps S1 to S9 shown in FIG. 7. The respective steps will be described below in detail.

### Step S1: Generation for Floor Plan

At first, the floor plan section 11 determines a chip size, hard blocks to be used, and arrangement positions of the hard blocks based on the net list D1 and the data D2 which have been stored in the storage unit 2, and generates the floor plan.

### Step S2: Arrangement of Power Supply

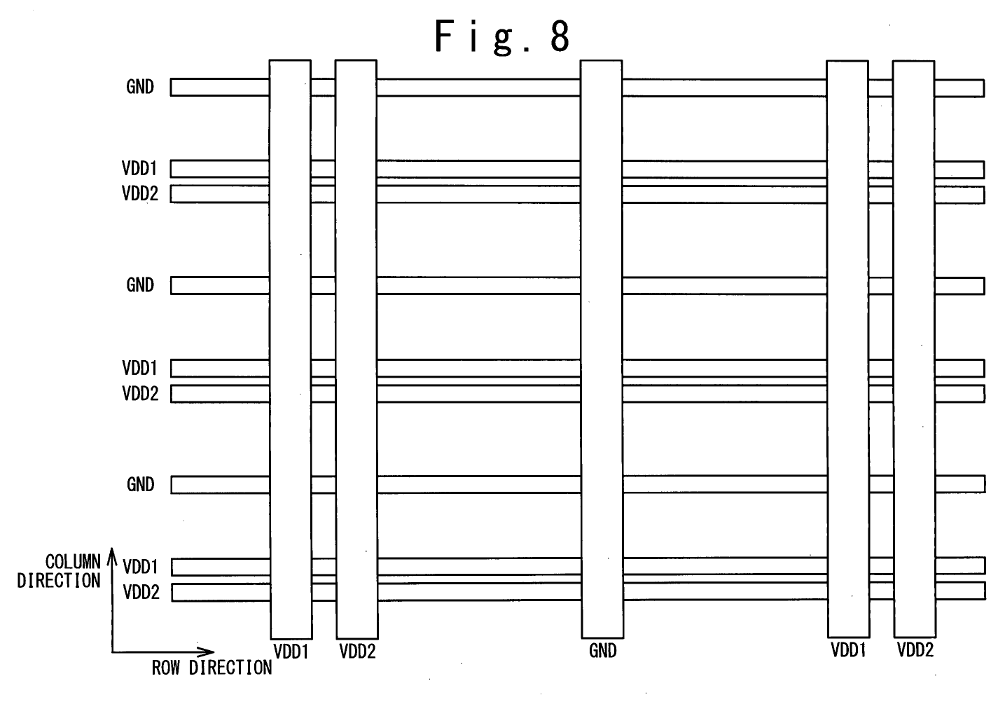

Subsequently, the power supply arranging section 12 arranges power supply interconnections for the hard blocks and standard cells in accordance with the floor plan, and generates a power supply arranged layout data. FIG. 8 is a conceptual diagram showing the power supply arranged layout data. In this embodiment, it is assumed that a plurality of (two kinds of) power supply interconnections (VDD1 and VDD2) and a ground interconnection GND are arranged, as shown in FIG. 8. The supplied voltages are assumed to be different between the first power supply VDD1 and the second power supply VDD2. The power supply arranging section 12 arranges the plurality of power supply interconnections (VDD1 and VDD2) and the ground interconnection GND in a row direction and a column direction.

### Step S3: Automatic Arrangement

In succession, the first automatic arranging section 13 arranges the standard cells in accordance with the power supply arranged layout data generated by the power supply arranging section 12, the net list D1, and the timing data D3, and then generates an automatically arranged layout data. The standard cells are automatically arranged by an automatically arranging tool using a timing driven method.

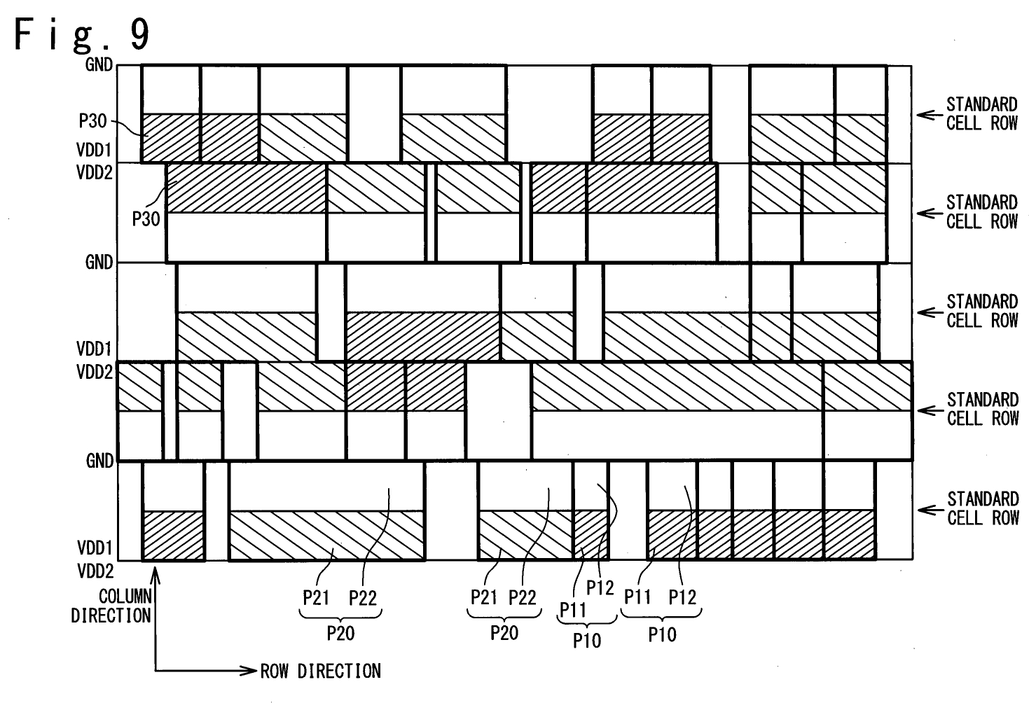

FIG. 9 is a conceptual diagram showing the automatically arranged layout data. As shown in FIG. 9, the standard cells have been arranged. It should be noted that the automatically arranged layout data also includes the power supply interconnections (VDD1 and VDD2) and the ground interconnection GND. However, the focal point of the description is placed on the arrangement of the standard cells. Thus, the interconnections are omitted. Here, the standard cells are grouped into the standard cells connected to the first power supply VDD1 and the standard cells connected to the second power supply VDD2. In this embodiment, the standard cell connected to the first power supply VDD1 is defined as a first standard cell P10, and the standard cell connected to the second power supply VDD2 is defied as a second standard cell P20. A plurality of the first standard cells P10 and a plurality of the second standard cells P20 are arranged. Also, the N-well of the first standard cell P10 is referred to as a first N-well P11, the P-well of the first standard cell is referred to as a first P-well P12, the N-well of the second standard cell P20 is referred to as a second N-well P21, and the P-well of the second standard cell P20 is referred to as a second P-well P22. Also, the common ground interconnection GND is assumed to be connected to the first P-well P12 and the second P-well P22. In the automatically arranged layout data, the first standard cells P10 and the second standard cells P20 are mixedly arranged.

Referring to FIG. 9, the standard cells are arranged to form a plurality of standard cell rows. In each of the plurality of standard cell rows, the standard cells are arranged in the row direction. Also, the plurality of standard cell rows are located in adjacent to one after another other in the column direction. In the adjacent standard cell rows, the standard cells are arranged such that the N-wells or the P-wells are adjacent in the column direction. Thus, the N-well and the P-well are not adjacent to each other between the standard cells adjacent to each other in the column direction. Accordingly, since the N-well and the P-well are adjacent to each other between the standard cells adjacent in the column direction, the leakage current never flows.

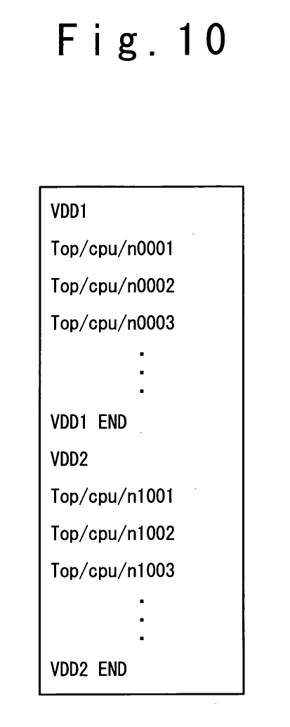

Also, the first automatic arranging section 13 generates the automatically arranged layout data and generates a power supply group list D4 to store in the storage unit 2. FIG. 10 is a conceptual diagram showing the power supply group list D4. The power supply group list D4 is a data indicating which of the power supply interconnections is connected to each standard cell. That is, by referring to the power supply group list D4, it is possible to identify whether each standard cell is the first standard cell P10 or the second standard cell P20. The power supply group list D4 includes a power supply name and an instance name. In the example shown in FIG. 10, the first standard cells whose instance names are [Top/cpu/n0001, Top/cpu/n0002, Top/cpu/n0003 . . . ] are connected to the power supply interconnection whose power supply name is [VDD1], and the second standard cells whose instance names are [Top/cpu/n1001, Top/cpu/n1002, Top/cpu/n1003 . . . ] are connected to the power supply interconnection whose power supply name is [VDD2].

### Step S4: Empty Cell Arrangement

Next, the empty cell arranging section 14 arranges empty cells P30 in accordance with the automatically arranged layout data and generates an empty cell arranged layout data. The empty cell P30 is a cell that is arranged in order to provide an interval between the standard cells connected to the different power supplies. The empty cell P30 is a cell to be finally removed, and is not required to include therein any pattern.

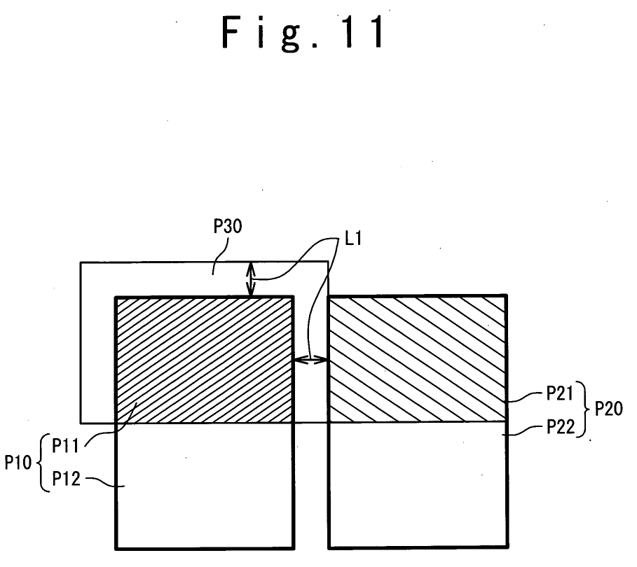

FIG. 11 is a diagram showing a position where the empty cell P30 is arranged. As shown in FIG. 11, the empty cell P30 is arranged in the area which is outside the first standard cell P10 and in which the distance from the first N-well P11 is equal to or less than a first distance L1. The first distance L1 is set as a distance (hereafter, referred to as a different voltage well interval) in which the leakage current does not flow between the first N-well P11 and the second N-well P21 in the second standard cell P20.

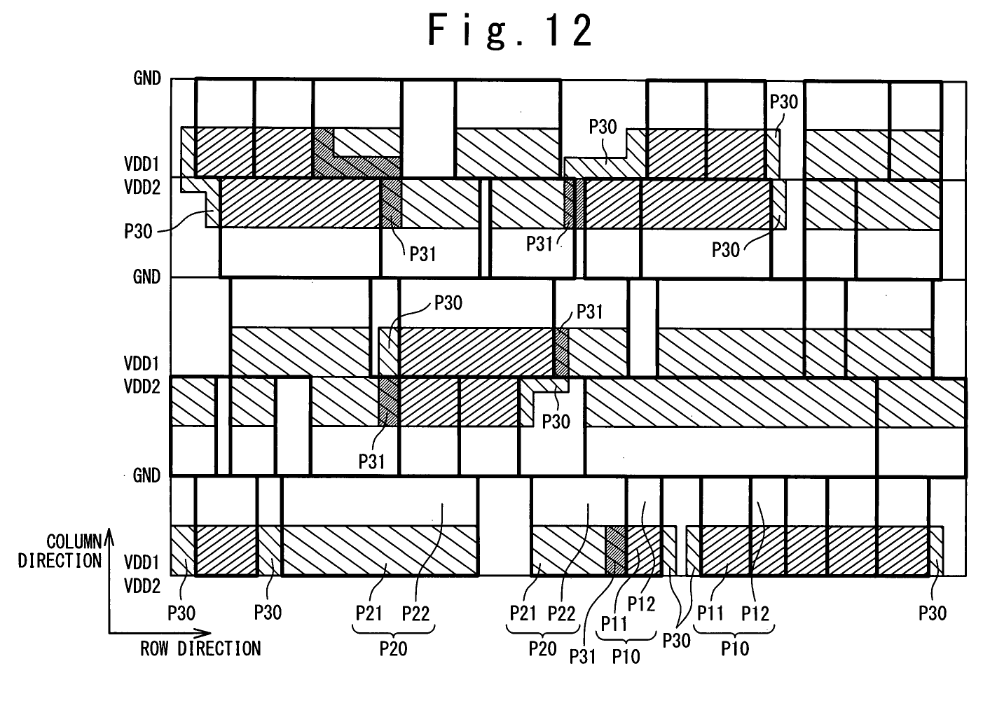

FIG. 12 is a conceptual diagram showing the empty cell arranged layout data. When the empty cell P30 is arranged, there is a case that an overlapping area P31 is generated in which the empty cell P30 and the second N-well P21 overlap. In this overlapping area P31, the first N-well P11 and the second N-well P21 approach to each other within the first distance L1. It should be noted that in FIG. 12, the empty cell P30 is arranged even in an area where it overlaps with the first N-well P11. However, in order to make the description easy, the area where the first N-well P11 and the empty cell P30 overlap with each other is not distinguished from the first N-well P11.

### Step S5: Setting of Shift Inhibition

In succession, the inhibition setting section 19 sets shift inhibition for the first standard cell P10 in accordance with the empty cell arranged layout data and the power supply group list D4.

### Step S6: Automatic Arrangement

Next, the second automatic arranging section 20 shifts or moves the standard cells (the second standard cells in this embodiment) to which the shift inhibition is not set, and generates a re-arranged layout data. Here, the second automatic arranging section 20 shifts each second standard cell P20 so that the overlapping area P31 is removed. In this embodiment, each second standard cell P20 is shifted or moved in the row direction so that the overlapping areas P31 are removed. The shift operation at this step may be carried out through the automatic arrangement using the timing driven method, similarly to the step S3. Since the overlapping regions P31 are removed, the interval that is greater than at least the first distance L1 (different voltage well interval L1) is provided between the first N-well P11 and the second N-well P21.

It should be noted that in this embodiment, a case will be described in which the two kinds of power supplies (VDD1 and VDD2) are used. However, even in a case of using the power supplies of three kinds or more, the area in which the wells applied with the different voltages approach to each other can be moved through the repetition of the operations of the steps S4 to S6. For example, in case of using the n kinds of the power supplies, the operation of the steps S4 to S6 is repeated (n-1) times, wherein the empty cells P30 are adjacently arranged at the step S4, and the standard cells for which the shift inhibition is set at the step S5 may be increased one kind of the cell at a time.

### Step S7: Empty Cell Removal

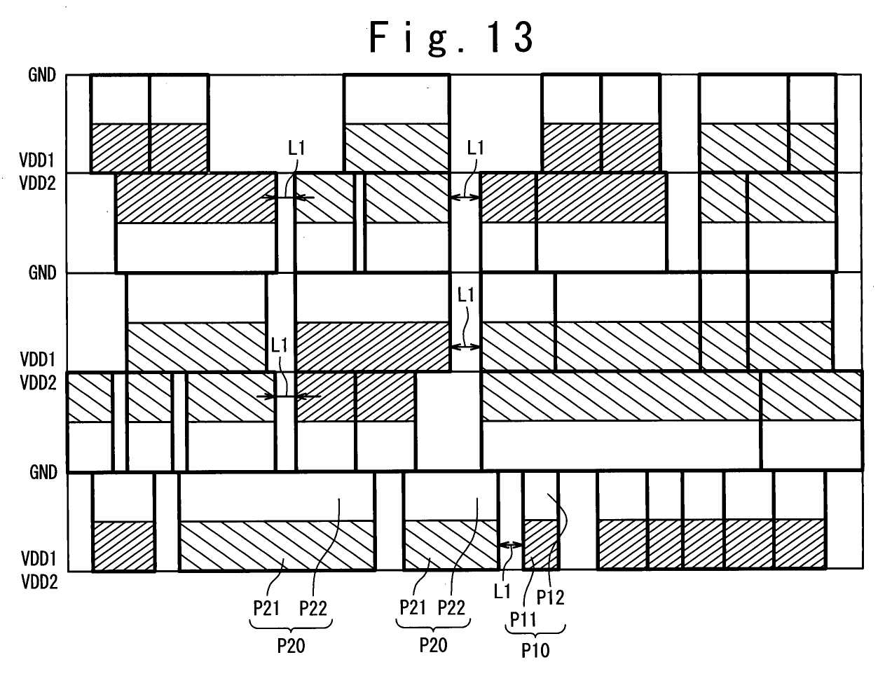

In succession, the empty cell removing section 16 removes the empty cells P30 in accordance with the re-arranged layout data and generates the empty cell removed layout data. FIG. 13 is a conceptual diagram showing the empty cell removed layout data. As shown in FIG. 13, the empty cells P30 are removed, and at least a different voltage interval is reserved between the first N-well P11 and the second N-well P21. It should be noted that the empty cell P30 can be removed by using the automatic layout tool.

### Step S8: Power Supply Connection

In succession, the power supply interconnection section 17 connects the respective standard cells, the power supply interconnections (VDD1 and VDD2) and the ground interconnection GND in accordance with the empty cell removed layout data and the net list D1, and then generates the power supply connected layout data.

### Step S9: Automatic Interconnection

Moreover, the automatic interconnection section 18 arranges signal lines between elements (between the hard blocks and the respective standard cells) in accordance with the power supply connected layout data. Also, the material of the signal line such as aluminum is determined.

The process of the steps S1 to S9 as mentioned above generates the layout pattern of the semiconductor device. It should be noted that when the standard cells and fill cells (cells embedded in gap) are added or changed, the process of the steps S4 to S8 is again executed. The fill cell is a cell that is embedded between the standard cells of the same voltage, and is a cell that includes therein the patterns of the N-well and the P-well.

According to this embodiment, the area for keeping the interval between the wells adjacent to each other is not required to be provided inside each standard cell. In the area where the wells applied with the same voltage are adjacent to each other, the interval is not always provided between the wells. Thus, the increase in the chip size can be suppressed to a minimum.

Also, since the area in which the standard cell is arranged for each power supply is not fixed, a plurality of kinds of standard cells can be mixedly arranged. Thus, the distance between the standard cells can be selected relatively freely, and the interconnection delay is difficult to occur.

In addition, at the step S6, the standard cells are re-arranged to eliminate a case that the wells of the different voltages are adjacent to each other. Thus, the different voltage well interval is reserved between the wells of the different voltages. That is, the leakage current is prevented between the wells of the different voltages.

### Second Embodiment

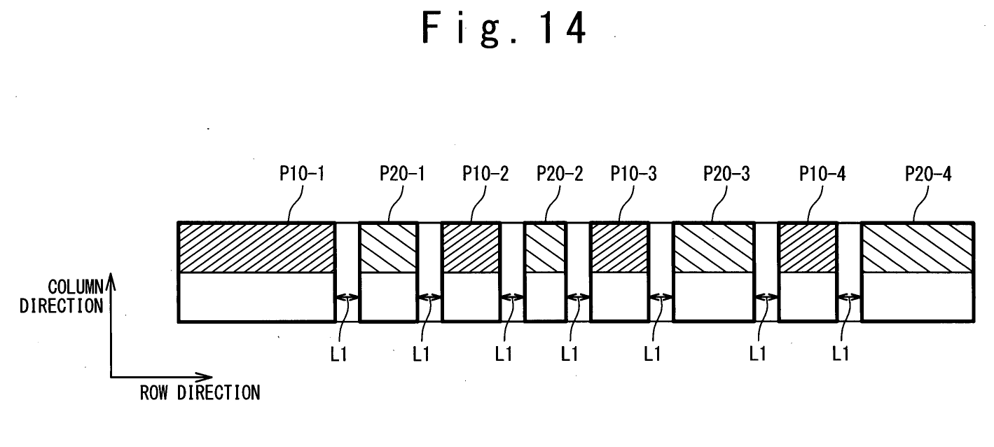

In succession, the layout design supporting apparatus according to a second embodiment of the present invention will be described below. According to the first embodiment, the different voltage well interval L1 is reserved only between the wells applied with the different voltages, to suppress the chip size. However, when the standard cells having the wells applied with the different voltages are alternately arranged at the step S3, the different voltage well interval L1 is set between every two of the standard cells, as a result. FIG. 14 is a diagram schematically showing the layout pattern finally designed when the first standard cells P10 and the second standard cells P20 are alternately arranged in the row direction at the step S3. FIG. 14 shows one standard cell row in the layout pattern. As shown in FIG. 14, the first standard cells P10 and the second standard cells P20 are alternately arranged at the interval of the different voltage well interval L1. Since the different voltage well interval L1 is set between the all adjacent two of the standard cells, the effect of suppressing the chip size is not sufficiently provided.

In the second embodiment, the chip size is suppressed eve if the standard cells having the wells applied with the different voltages are alternately arranged, as mentioned above.

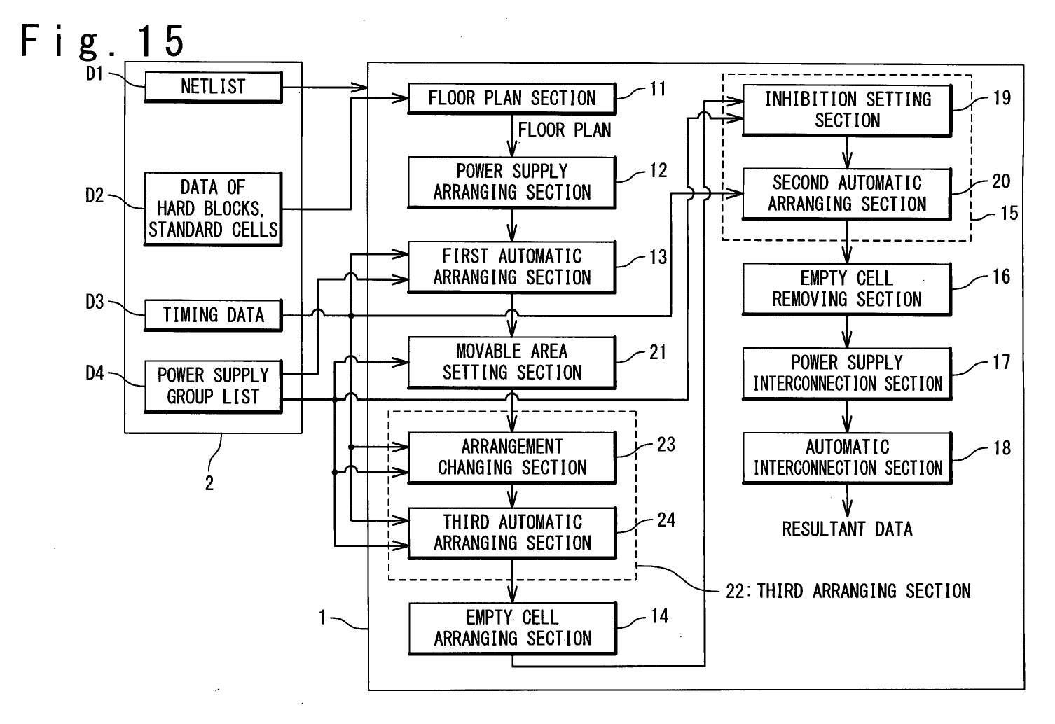

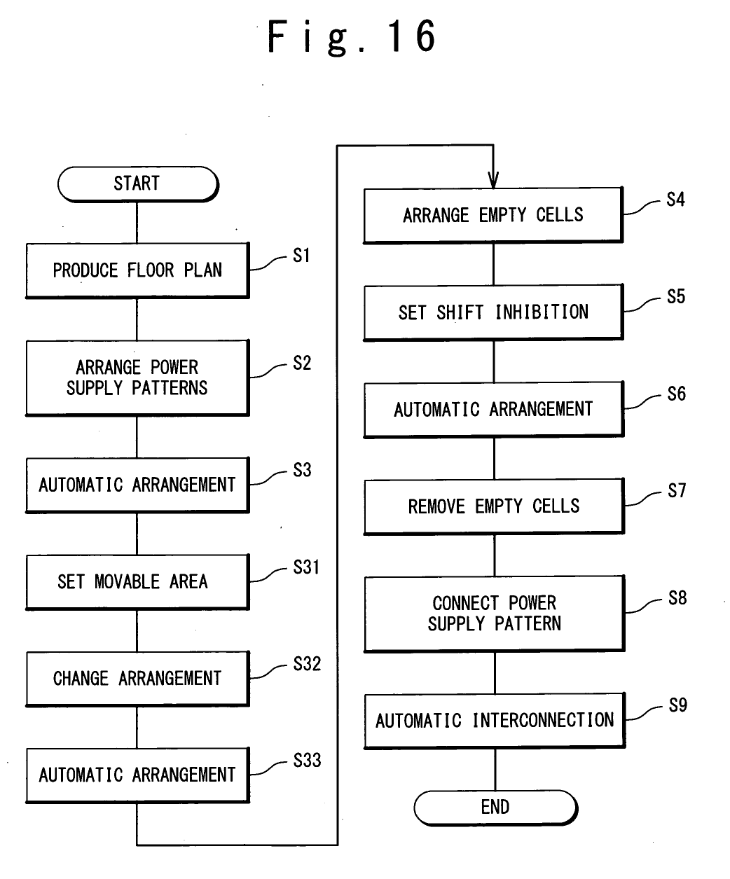

FIG. 15 is a function block diagram showing the function configuration of the layout design supporting apparatus for a semiconductor device according to the second embodiment. In the layout design supporting apparatus in this embodiment, a movable area setting section 21 and a third arranging section 22 are added, as compared with the first embodiment. The third arranging section 22 contains an arrangement changing section 23 and a third automatic arranging section 24. Also, FIG. 16 is a flowchart showing the operating method of the layout design supporting apparatus according to this embodiment. The process of the steps S31 to S33 is added as compared with the first embodiment. The configuration and operation other than the above are similar to those in the first embodiment.

The method of designing the layout of the semiconductor device according to this embodiment will be described below in detail. However, the descriptions of the configuration and operation similar to those in the first embodiment are omitted.

### Step S31: Setting of Movable Area

As shown in FIGS. 15 and 16, in this embodiment, after the standard cells are arranged at the step S3, the movable area setting section 21 sets a movable destination area to each standard cell. The movable destination area indicates the area to which each standard cell can be moved or shifted. When each standard cell arranged at the step S3 is moved to a destination, there is a case that a desirable property cannot be obtained, because of the reason that the distance of the interconnection through which the respective standard cells are linked becomes too long. The movable destination area represents the area in which the desirable property can be obtained even if each standard cell is moved.

The movable destination area can be calculated in accordance with a capacitance value limit set to the output terminal of each standard cell. A more specific example is indicated below. It is supposed that the capacitance value limit of 1 pF is set to the output terminal of each standard cell and a capacitance value between the standard cells is limited to 0.9 pF under the consideration of the input terminal capacitance of the standard cell to be connected. Also, it is supposed that a capacitance of the interconnection of 10 μm is 0.1 pF. At this time, in order that the capacitance value of the interconnection falls within the limit range (within 0.9 pF), the length of the interconnection is required to be 90 μm or less. Thus, the distance (hereinafter, to be referred to as a second distance L2) between the two standard cells connected to each other is required to be 90 μm or less. In this case, the movable destination area set to a certain standard cell is set to the area in which the distance from the standard cell of the connection destination is 90 μm or less.

It should be noted that the second distance L2 may be set separately for each kind of the standard cell, or one value may be set for the plurality of standard cells.

### Step S32: Change Arrangement

In succession, the arrangement changing section 23 in the third arranging section 22 changes the arrangement of each standard cell in the automatically arranged layout data that has been generated by the first automatic arranging section 13, and then generates the arrangement changed layout data. The third arranging section 22 changes the arrangement of the respective standard cells so that the first standard cells P10 are arranged closely to each other and the second standard cells P20 are arranged closely to each other. At this time, the arrangement changing section 23 moves or shifts the respective standard cells within the range of the movable destination area set by the movable area setting section 21. Specifically, this refers to the power supply group list D4 to move one first standard cell to the vicinity of another first standard cell that is firstly written among the first standard cells. The cell that cannot be arranged in the vicinity of the firstly written first standard cell, namely, the cell that cannot be arranged within a predetermined range from the firstly written first standard cell within the range of the movable destination area is not moved. The arrangement changing section 23, after moving the first standard cells, again moves the remaining first standard cells that have not been moved. That is, the remaining first standard cells are moved to the vicinity of the first standard cells that is written at the highest order in the power supply group list D4, among the first standard cells that have not moved. As a result, the first standard cells are collectively arranged within the range of the constraint caused by the movable destination area. The arrangement changing section 23 performs the similar process on the standard cells of the other kinds.

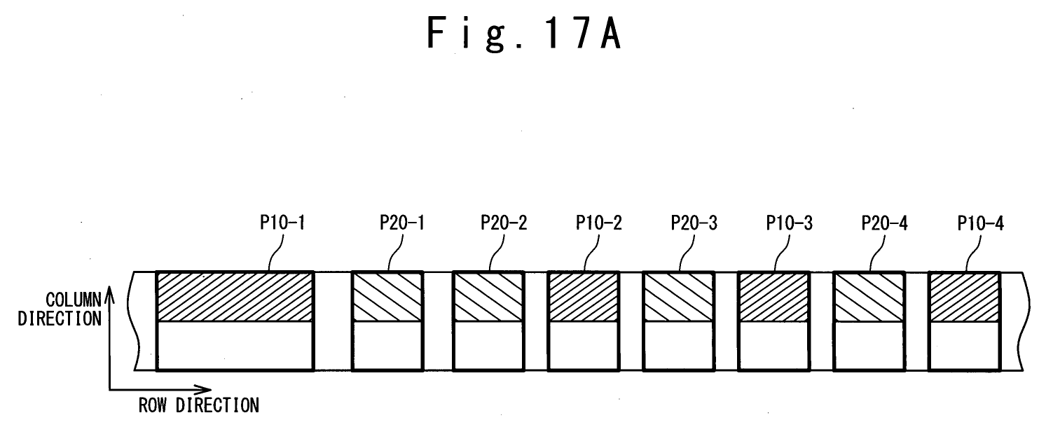

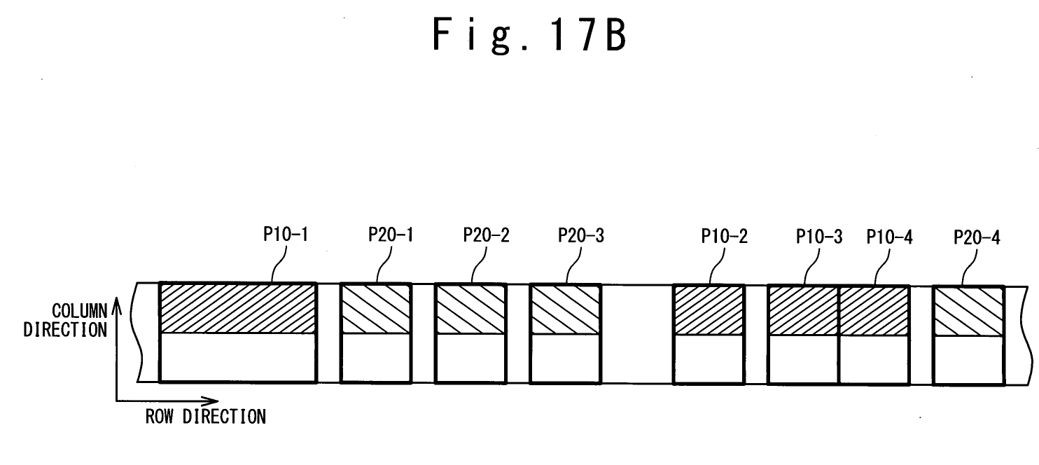

The operation of the arrangement changing section 23 will be specifically described with reference to FIGS. 17A and 17B. FIG. 17A is a conceptual diagram showing the arrangement of the standard cells on a standard cell row of the automatically arranged layout data. FIG. 17B is a conceptual diagram showing the arrangement changed layout data generated in accordance with the automatically arranged layout data shown in FIG. 17A. As shown in FIG. 17A, in the automatically arranged layout data, the first standard cells (P10-1 to P10-4) and the second standard cells (P20-1 to P20-4) are assumed to be arranged in a random order in the row direction. For example, the second standard cell P20-3 is arranged between the first standard cells P10-2 and P10-3. On the contrary, as shown in FIG. 17B, in the arrangement changed layout data, the second standard cell P20-3 is moved or shifted to the vicinity of the second standard cell P20-2, and the second standard cells (P20-1 to P20-3) are collectively arranged. Similarly, the first standard cells (P10-2, P10-4) are also moved or shifted such that the first standard cells (P10-2 to P10-4) are collectively arranged.

### Step S33: Automatic Arrangement

In succession, the third automatic arranging section 24 adjusts the arrangement of the standard cells in the arrangement changed layout data. There is a possibility that the timing is deteriorated because each standard cell is moved through the process of the step S32. The third automatic arranging section 24 adjusts the arrangement of the respective standard cells, in order to modify the timing. The third automatic arranging section 24 uses the function of the timing driven arrangement and consequently performs the micro adjustment on the arrangement of the respective standard cells and then modifies the timing.

### Step S4 to Step S9:

The subsequent process is similar to the process of the steps S4 to S9 in the first embodiment. Thus, the detailed description is omitted. Similarly to the first embodiment, after the empty cell is arranged (Step S4), the movement inhibition is set (Step S5), and the automatic arrangement is carried out (Step S6). Thus, the different voltage well interval L1 is provided only between the first standard cell and the second standard cell.

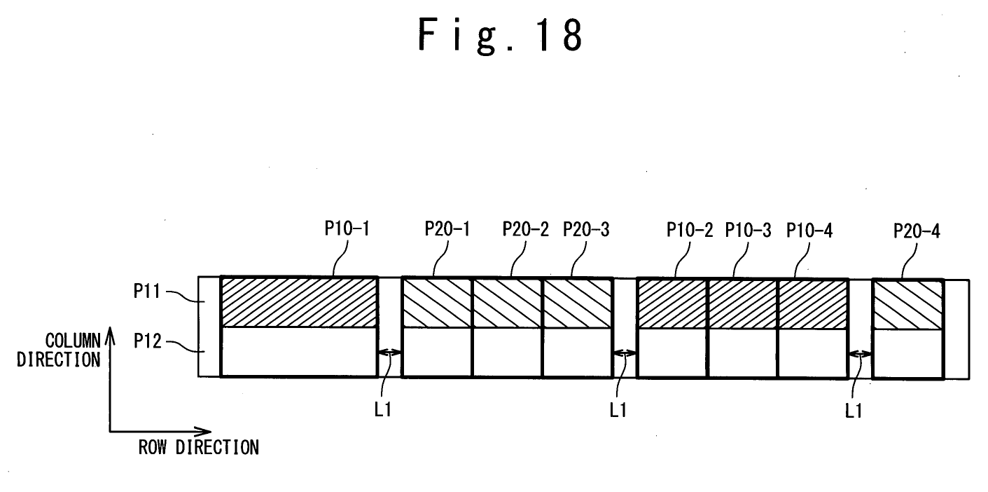

FIG. 18 is a conceptual diagram showing the layout data after the process until the step 6 is performed on the arrangement changed layout data shown in FIG. 17B. As shown in FIG. 18, the different voltage well interval L1 is provided between the first standard cell P10 and the second standard cell P20. On the other hand, the second standard cells (P20-1 to P20-3) are collectively arranged, and the interval is not provided between the second standard cells. Similarly, the first standard cells (P10-2 to P10-4) are collectively arranged without any provision of the interval.

In this way, according to this embodiment, the arrangement of the standard cells is changed such that the standard cells having the wells applied with the same voltage are collectively arranged by the third arranging section 22, even if the standard cells having the wells applied with the different voltages are alternately arranged in the arranged layout data. As a result, finally, the positions to which the different voltage well interval L1 is provided can be made less, and thereby the chip size can be effectively restricted.

It should be noted that this embodiment has been described on a case that the step S31 is executed between the steps S3 and S32. That is, an example has been described that, after the automatic arrangement is executed at the step S3, the movable area setting section 31 sets the movable destination area and calculates the second distance L2 at this time. However, the setting of the second distance L2 may be executed at any stage, in case of the stage before the arrangement of the standard cells is changed at the step S32. That is, the process of the step S31 is not limited between the steps S3 and S32.

### COMPARISON EXAMPLE

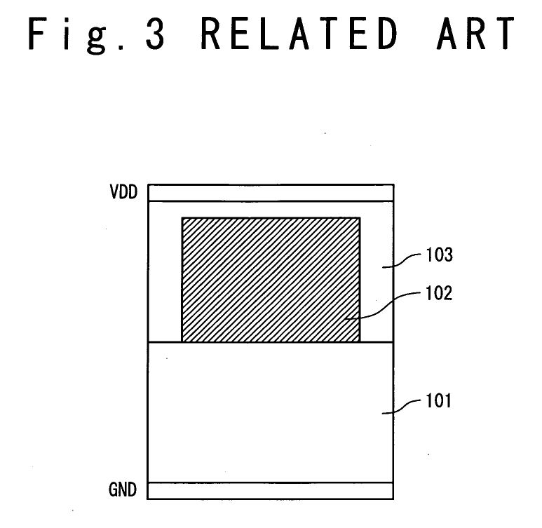

According to the present invention, as the result of a calculation by the inventor, the chip size reduction of 10% or more could be attained, as compared with a case of providing the area between the well and the outer circumference of the standard cell, as shown in FIG. 3. The calculation by the inventor will be described below.

As a plurality of kinds of standard cells, 500 standard cells A having a well of an A voltage and 500 standard cells B having a well of a B voltage are assumed to be used. That is, the number of the standard cells in the generated layout pattern is assumed to be 1000.

The size of the standard cell A is assumed such that its height (column direction length) is 5.04 μm and its width (row direction length) is 8.4 μm. The size of the standard cell B is assumed to be the size in which the interval required between the wells of the different voltages is 1.6 μm and the its width is longer than that of the standard cell A by 1.6 μm on either side in the row direction. It should be noted that the interval is actually required to be provided also in the column direction. However, in this case, it is not considered. That is, the size of the standard cell B is assumed such that its height (column direction length) is 5.04 μm and its width direction is (8.4 μm+1.6 μm×2=11.6 μm).

The size of the layout pattern generated as the comparison example becomes 50400 (μm²) in accordance with the following equation (1):

(5.04 (μm)×8.4 (μm)×500 (cells)+11.6 (μm)×5.04 (μm)×500 (cells)=50400 (μm²) (1)

### EXAMPLE

Similarly to the comparison example, the 500 standard cells A having the well of the A voltage and the 500 standard cells B having the well of the B voltage are assumed to be used. However, the sizes of the standard cells A and B in this example are assumed to be the size equal to the standard cell A in the comparison example (its height is 5.04 μm and its width is 8.4 μm). Also, the interval required between the wells of the different voltages is assumed to be 1.6 μm equal to that of the comparison example.

It is assumed in the example that, as described in the above-mentioned embodiments, the empty cell having the width of 1.6 μm is arranged for the standard cell A, and re-arranged so that the empty cell does not overlap with the standard cell B. As a result, the five standard cells B are arranged adjacent to each other in the row direction without any space, and the different voltage interval of 1.6 μm is provided on both sides of the five standard cells B in the row direction.

The size of the layout pattern generated in the example is represented by the following equation (2):

Total area of (area of 500 standard cells A)+(area of 500 standard cells B)+(gap provided due to different voltage interval) (2)

Here, [Total area of area of 500 standard cells+different voltage interval] corresponds to 100 [area of 5 standard cells B+area of gap on both sides of standard cell B (area Corresponding to two gaps). Thus, [area of 500 standard cells B+area of different voltage interval] is 22780.8 (μm²) from the following equation (3):

(5×8.4×5.04+1.6×2×5.04)×100=22780.8 (μm²) (3)

On the other hand, [Area of 500 standard cells A] is 21168 (μm²) from the following equation (4):

500×8.4×5.04=21168 (μm²) (4)

Thus, the entire size of the layout pattern generated in the example is 43948.8 (μm²) from the following equation (5):

22780.8+21168=43948.8 (μm²) (5)

### (Comparison)

The size of the layout pattern generated in the example can be reduced by about 13% in the area, as compared with the layout pattern generated in the comparison example, as represented by the following equation (6):

(50400−43948.8)/50400×100=12.8 (%) (6)

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A layout designing method of a semiconductor device, comprising:
arranging a first standard cell with a first well and a second standard cell with a second well, wherein said first well and said second well are applied with different voltages, respectively;
arranging an empty cell in an area that a distance from said first well falls within a first distance; and
moving said second standard cell such that said empty cell does not overlap with said empty cell, when said empty cell overlaps with said second well.

2. The layout designing method according to claim 1, further comprising:
removing said empty cell after said moving.

3. The layout designing method according to claim 1, wherein said moving comprises:
setting inhibition of movement of said first standard cell; and
moving said second standard cell such that said empty cell and said second well do not overlap with each other, after said setting.

4. The layout designing method according to claim 1, further comprising:
determining a layout of a first power supply and a second power supply; and
connecting said first standard cell with said first power supply and said second standard cell with said second power supply.

5. The layout designing method according to claim 1, wherein said arranging a first standard cell and a second standard cell, comprises:
arranging a plurality of said first standard cells and a plurality of said second standard cells,
wherein said layout designing method further comprises:
re-arranging said plurality of first standard cells such that said plurality of first standard cells are collectively arranged, and
said arranging the empty cell is carried out after said re-arranging.

6. The layout designing method according to claim 5, further comprising:
determining a movable destination area to which said first standard cells can be moved,
wherein said re-arranging comprises:
collectively arranging said first standard cells by moving said first standard cells to said removable destination area.

7. A layout design supporting apparatus for a semiconductor device, comprising:
a first arranging section configured to arrange a first standard cell with a first well and a second standard cells with a second well, to generate an arranged layout data, wherein different voltages are applied to said first and second wells, respectively;
an empty cell arranging section configured to arrange an empty cell in an area within a first distance from said first well, to generate an empty cell arranged layout data; and
a second arranging section configured to re-arrange said second standard cell such that said empty cell and said second well do not overlap, when said empty cell overlaps with said second standard cell in the empty cell arranged layout data.

8. The layout design supporting apparatus according to claim 7, further comprising:
an empty cell removing section configured to remove said empty cell from the re-arranged layout data, to generate an empty cell removed layout data.

9. The layout design supporting apparatus according to claim 7, wherein said second arranging section comprises:
an inhibition setting section configured to set to inhibit said first standard cell from being moved; and
a second automatic arranging section configured to move said second standard cell for said empty cell not to overlap with said second well.

10. The layout design supporting apparatus according to claim 7, further comprising:
a power supply arranging section configured to determine a layout of a first power supply and a second power supply; and
a power supply interconnection section configured to interconnect said first standard cell with said first power supply and said second standard cell with said second power supply based on said empty cell removed layout data.

11. The layout design supporting apparatus according to claim 7, wherein said first arranging section arranges a plurality of said first standard cells and a plurality of said second standard cells, and
said layout design supporting apparatus further comprises:
a third arranging section configured to re-arrange said plurality of first standard cells in the arranged layout data such that said plurality of first standard cells are collectively located, to generate a re-arranged layout data, and
said empty cell arranging section arranges the empty cell in said re-arranged layout data.

12. The layout design supporting apparatus according to claim 11, further comprising:
a movable area setting section configured to set a movable destination area to which said first standard cell can be moved,
wherein said third arranging section moves said plurality of first standard cells into said movable destination area to collectively arrange said plurality of first standard cells.

13. A computer-readable recording medium in which a computer-readable program code is stored for realizing a layout designing method of a semiconductor device, said layout designing method comprising:
arranging a first standard cell with a first well and a second standard cell with a second well, wherein said first well and said second well are applied with different voltages, respectively;
arranging an empty cell in an area that a distance from said first well falls within a first distance; and
moving said second standard cell such that said empty cell does not overlap with said empty cell, when said empty cell overlaps with said second well.

14. The computer-readable recording medium according to claim 13, wherein said layout designing method further comprises:
removing said empty cell after said moving.

15. The computer-readable recording medium according to claim 13, wherein said moving comprises:
setting inhibition of movement of said first standard cell; and
moving said second standard cell such that said empty cell and said second well do not overlap with each other, after said setting.

16. The computer-readable recording medium according to claim 13, wherein said layout designing method further comprises:
determining a layout of a first power supply and a second power supply; and
connecting said first standard cell with said first power supply and said second standard cell with said second power supply.

17. The computer-readable recording medium according to claim 13, wherein said arranging a first standard cell and a second standard cell, comprises:
arranging a plurality of said first standard cells and a plurality of said second standard cells,
wherein said layout designing method further comprises:
re-arranging said plurality of first standard cells such that said plurality of first standard cells are collectively arranged, and
said arranging the empty cell is carried out after said re-arranging.

18. The computer-readable recording medium according to claim 17, wherein said layout designing method further comprises:
determining a movable destination area to which said first standard cells can be moved,
wherein said re-arranging comprises:
collectively arranging said first standard cells by moving said first standard cells to said removable destination area.
